(19) United States
(12) Patent Application Publication
(10) Pub. No.: US 2011/0260922 A1
(43) Pub. Date: Oct. 27, 2011

(54) MAPPING LOCATIONS BASED ON RECEIVED SIGNAL STRENGTHS

(75) Inventors: Chuntao Zhang, Streamwood, IL (US); Thomas S. Babin, Lake Zurich, IL (US); Timothy J. Collins, Homer Glen, IL (US); Julius S. Gyorfi, Vernon Hills, IL (US); Tom Mathew, Skokie, IL (US); Swee M. Mok, Palatine, IL (US)

(73) Assignee: MOTOROLA, INC., Schaumburg, IL (US)

(21) Appl. No.: 12/764,476

(22) Filed: Apr. 21, 2010

(51) Int. Cl. G01S 3/02

(52) U.S. Cl. 342/451

(57) ABSTRACT

Disclosed is a system for updating an RSSI-based map. A scanning devices notes which tags are seen during a scan and measures a “proxy distance” from the scanning device to each tag. When the scan is initiated, the scanning device measures the RSSIs from the local WAPs. The current location of the scanning device is determined by triangulating from the proxy distances of the scanned tags. That location is then correlated with the contemporaneously measured RSSIs. The correlation is used to update the RSSI-based map. In some embodiments, it is not the scanning device that measures the RSSIs. Instead, the WAPs measure the RSSIs from the scanning device whenever the scanning device transmits the results of a scan. In some embodiments, the operator of the mapped environment places scannable tags at fixed locations. Scans of these fixed-location tags are especially useful when determining the current location of the scanning device.

### FIELD OF THE INVENTION

The present invention is related generally to electronic location-finding and, more particularly, to mapping locations in terms of received radio signals.

### BACKGROUND OF THE INVENTION

Location-based services are becoming increasingly common. These services depend upon a user knowing where he is currently located to an accuracy of, say, a meter or two. (Some services depend upon a device carried by the user, rather than the user himself, knowing where it is located.) As one example, a shopping device carried by a customer in a grocery store could track the customer's location and, based on that location, could present advertisements for products that are currently in front of the user. In a related example, the customer could query the device for instructions on how to get from where he is currently located to the location of a desired product.

The above examples may remind the reader of GPS-based location devices that are now common in automobiles and that are favored by back-country hikers. GPS can be very useful for these services. However, GPS is often useless when the user is located indoors. This is because building structures may block or distort GPS signals so much that GPS receivers are worthless within the building.

To provide location-based services indoors, it is known to provide radio beacons within a building. A user-carried mobile device reads signals from those beacons and calculates its location accordingly. In some instances, these radio beacons are the wireless-access points (WAPs) that provide data services to the mobile devices within the building. These WAPs need not send out special location signals; instead, the mobile devices notes the strengths (RSSIs) of the data signals that it receives from a number of WAPs in the building. In a very simple case, the mobile device uses the RSSIs to roughly determine its distance from each WAP, and (knowing which signal came from which WAP and where the WAPs are located) the mobile device then triangulates to determine its current position.

In real life, the situation is often much more complicated than that. In many indoor environments (e.g., warehouses or large stores), metal in the building infrastructure and in the items stored in the building attenuates, reflects, and generally distorts radio signals within the building. As a result, an RSSI measured by a mobile device cannot be easily turned into a measurement of the distance from the source WAP to the receiving mobile device.

However, location-based services are often of great value particularly in these large-building environments for, e.g., quickly locating and tracking inventory. As a result, an operator of such a building may choose to go to the great trouble and expense of creating a map that correlates RSSIs to physical locations within the building. Because (by assumption) this map cannot be created by simple triangulation, the map is created by sending a user carrying a mobile device to selected grid points within the building. The mobile device records the RSSIs at each grid point. The map is then a dataset that correlates each grid point with the RSSIs recorded at that grid point. To use the map, when a mobile device needs to know its current location, it measures the RSSIs it is currently reading and sends those measurements to a map server. The map server reviews the RSSIs recorded during the mapping procedure, compares them with the RSSIs the mobile device is currently reading, determines the mobile device's current location with respect to nearby mapped grid points (possibly after some interpolation), and then sends the location information to the mobile device.

This method works well in practice, but it is very expensive to create the original map and can be even more expensive to recalibrate that map to keep it up to date. When creating the map, the user's location at each selected grid point must be precisely known. This makes mapping each grid point somewhat costly. In addition, the selected grid points should be close to each other, say no farther apart than about one meter, to obtain the required location accuracy. (The closer together the grid points are, the more accurate and thus the more useful is the resultant map.) A large warehouse can easily require the mapping of tens of thousand of grid points. Even worse, the building's radio environment may change quickly as walls or shelving units are installed or removed, as heavy equipment is moved, and as the inventory within the building changes day by day. Any of these changes can throw off the calibration of the map, making re-mapping an ongoing, and potentially extremely costly, task.

### BRIEF SUMMARY

The above considerations, and others, are addressed by the present invention, which can be understood by referring to the specification, drawings, and claims. According to aspects of the present invention, an RSSI-based map of a particular environment (e.g., the inside of a warehouse or large store) is updated whenever a user initiates a scan. The scanning device notes which tags are seen during the scan and measures a “proxy distance” from the scanning device to each tag. Also, when the scan is initiated, the scanning device measures the RSSIs from the local WAPs. The current location of the scanning device is determined by triangulating from the proxy distances of the scanned tags. That location is then correlated with the contemporaneously measured RSSIs. The correlation is used to update the RSSI-based map. Thus, the map is updated whenever a user goes out to find a product or to scan for inventory without incurring a special cost simply for re-calibrating the map.

In some embodiments, it is not the scanning device that measures the RSSIs. Instead, the WAPs measure the RSSIs from the scanning device whenever the scanning device transmits the results of a scan. As above, the scanned tags give the current location of the scanning device, and that location is correlated with the contemporaneously measured RSSIs in the map.

In some embodiments, the operator of the mapped environment places scannable tags at fixed locations. These tags mark, for example, storage bins or shelves. These tags do not move (unlike tags on inventory items), and their locations are known. Thus, scans of these fixed-location tags are especially useful when determining the current location of the scanning device. In some embodiments, the mapping is based solely on fixed-location tags.

Any known types of scannable tags can be used with the present invention. For example, tags can be readable by radio (RFID) or by laser scanning.

In some embodiments, the map is stored and updated on a map server remote from the scanning devices. When the map server receives scan results and contemporaneously measured RSSIs (whether measured by the scanning device or by the WAPs), the map server updates its current map by correlating the current location of the scanning device with the RSSIs. Map information is transferred between the map server and the scanning devices by way of the WAPs.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIGS. 1a and 1b are overviews of a representational environment in which the present invention may be practiced;

FIG. 2 is a schematic drawing of an exemplary scanning device;

FIG. 3 is a schematic drawing of an exemplary map server; and

FIGS. 4a and 4b together are a flowchart of an exemplary method for re-calibrating a map during a scan.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

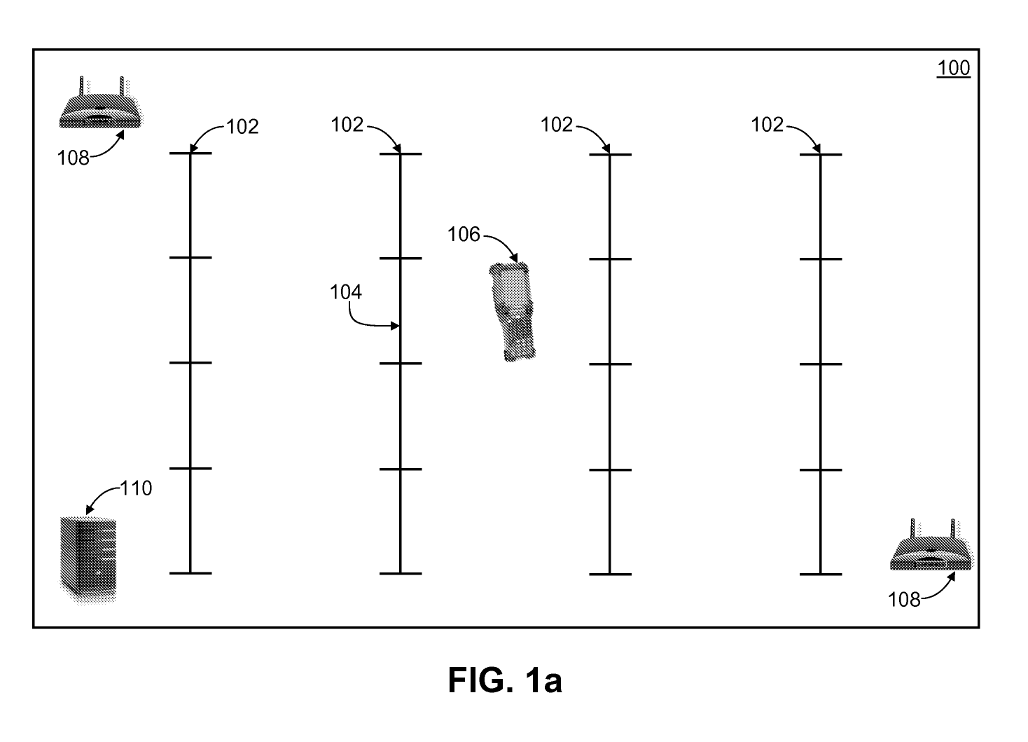

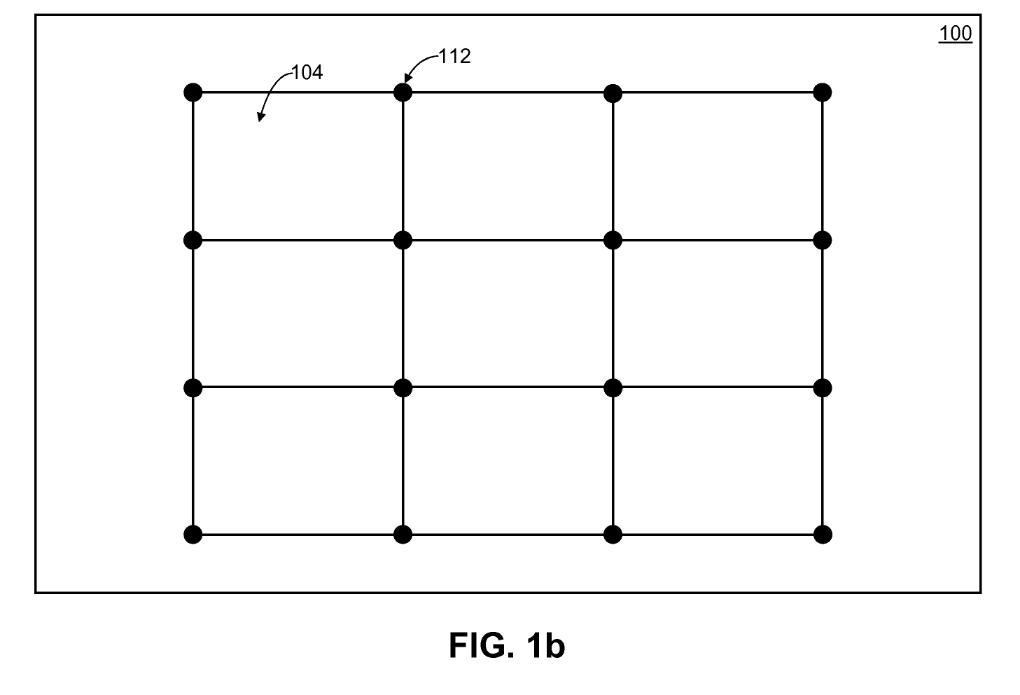

The present discussion illustrates aspects of the current invention with reference to the stylized layout of a typical warehouse or store 100 of FIG. 1a. A warehouse 100 often includes numerous rows 102 of shelves or bins 104. To allow the warehouser to track the merchandise, each type of merchandise is assigned to be stored on one or more particular shelves 104.

Inventorying the merchandise stored in the warehouse 100 is an ongoing task. As part of the inventory process, the contents of the shelves 104 are checked to make sure that all of the merchandise is properly stored and to check that the expected amount of merchandise is present in the warehouse 100. To perform the inventory, a user is given a hand-held scanning device 106. The scanning device 106 scans for tags affixed to the merchandise and records the tags found during the scan. Some scanning devices 106 use a laser to read bar-code tags (e.g., the UPC tags found on grocery-store items); other scanning devices 106 use a radio to read RFID tags.

The scanning device 106 communicates with one or more WAPs 108 (e.g., Wi-Fi hubs) installed throughout the warehouse 100. The scanning device 106 communicates through the WAPs 108 to a map server 110 that contains inventory information and a map that correlates RSSIs from the WAPs 108 with locations in the warehouse 100. By measuring the RSSIs as seen at the scanning device 106 and then consulting the map, the current location of the scanning device 106 can be determined. Aspects of the present invention aim to keep that map up to date.

FIG. 1b shows an array of shelves 104. The shelves are tagged with RFID or laser-scan tags 112. (FIG. 1b shows one embodiment of the tagged shelves 104, but the positioning and number of tags 112 can be varied to optimize the detection of the tags 112, the variations among embodiments based on particularities of the scanning environment.) As explained in greater detail below, a scan registers these tags 112 (as well as registering tags on merchandise). According to aspects of the present invention, the scanning of these tags 112 is used to determine the current location of the scanning device 106.

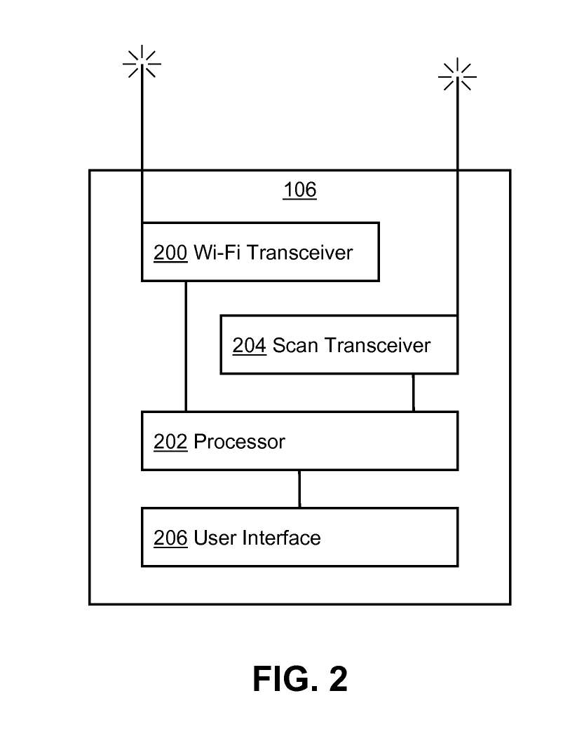

FIG. 2 shows some relevant elements of a typical scanning device 106. A transceiver 200 allows communication through the WAPs 108 to the map server 110. A second transceiver 204 performs the scan (laser or radio). A processor 202 runs the two transceivers 200, 204 and controls a user interface 206. The user interface 206 receives commands from the user (e.g., a command to initiate a scan) and presents results of the scan.

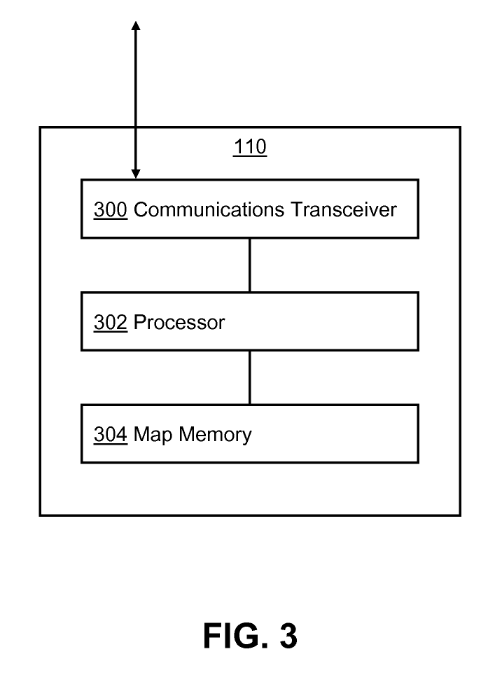

FIG. 3 shows some relevant elements of a typical map server 110. A transceiver 300 (often LAN-based) allows communication through the WAPs 108 to the scanning device 106. A processor 302 runs the transceiver 300 and updates the map stored in the memory 304.

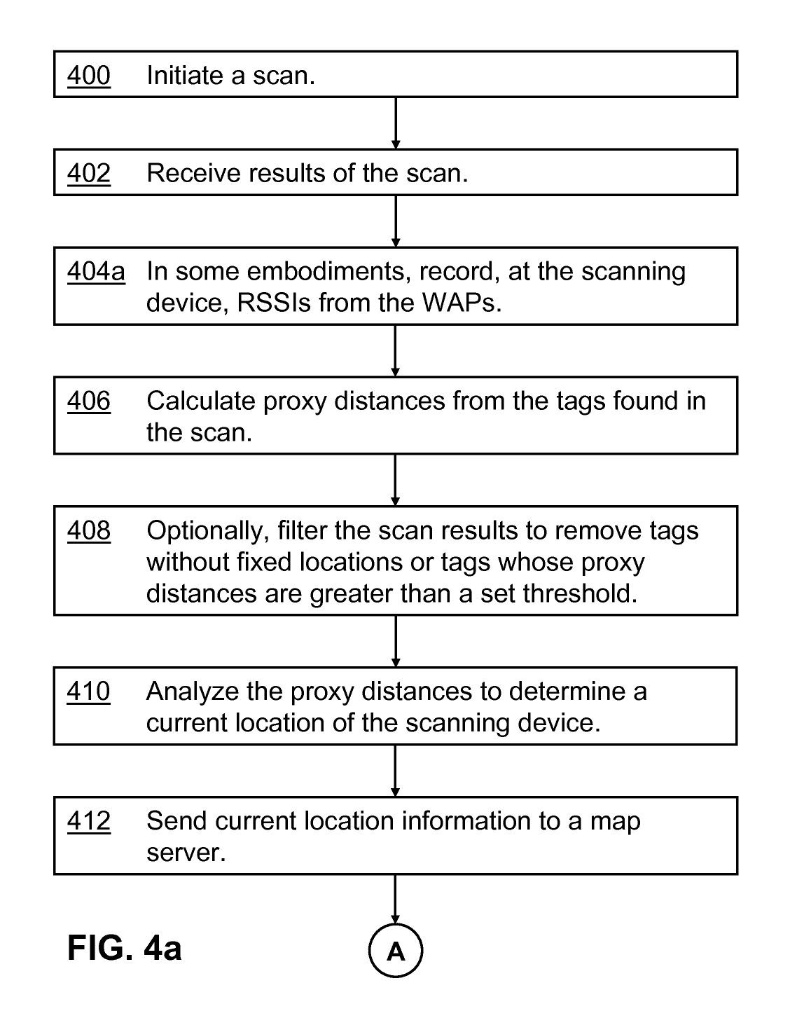

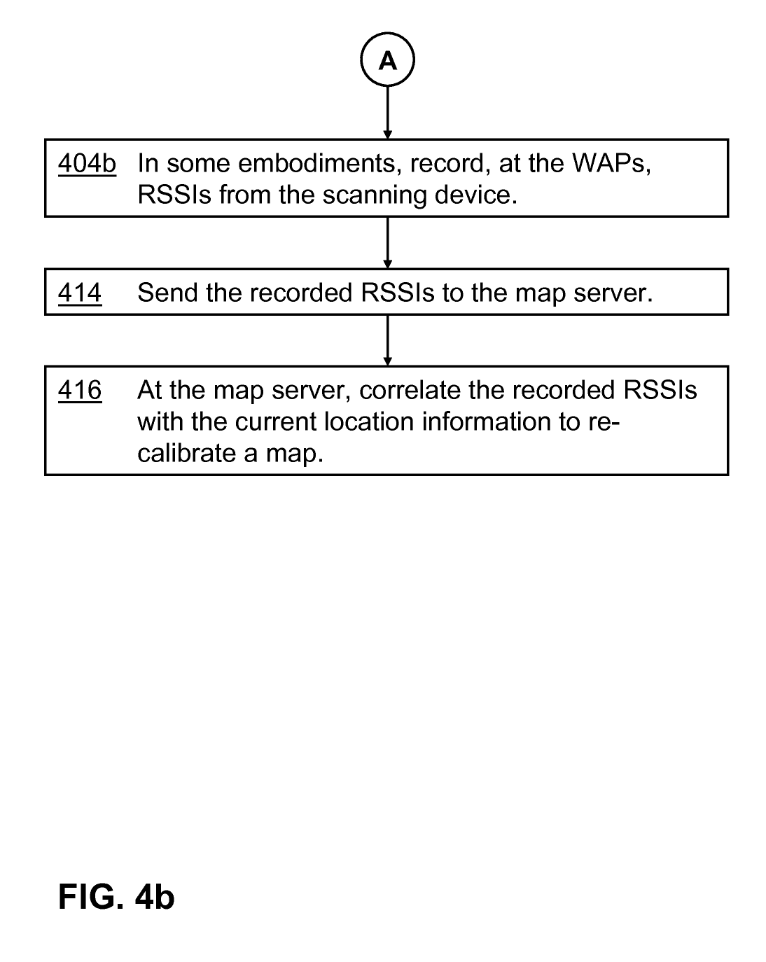

FIGS. 4a and 4b present a method, according to aspects of the present invention, for updating the map stored in the memory 304 of the map server 110. Before the method begins, the user of the scanning device 106 is told to scan a particular shelf 104. The scan may, for example, be part of a procedure for taking an inventory of the warehouse 100. The command could be transmitted from a central server (possibly the same device hosting the map server 110) and then delivered to the scanning device 106 via a WAP 108. The user approaches the target location 104. To do so, for example, the scanning device 106 can analyze the RSSIs it is receiving from the WAPs 108, query the existing map, and then know its location in the warehouse 100. The scanning device 106 then tells the user how to come close to the target location 104. In some embodiments, the map server 110 knows approximately where the user is currently standing (e.g., near the previous target location) and sends instructions to the user to get him close to the next target location 104.

The method of FIGS. 4a and 4b properly begins in step 400 when the user, close to the target location 104, initiates a scan. The scanning device 106 receives the results of the scan in step 402. At a minimum, the results of the scan include a list of tags read during the scan.

In some embodiments, step 404a occurs at roughly the same time as steps 400 and 402. In these embodiments, the scanning device 106 records the RSSIs it is currently receiving from the WAPs 108. (See the discussion below of step 404b in FIG. 4b for alternative embodiments.)

In step 406, an actual distance or a “proxy” distance is associated with each tag on the list of tags read during the scan. This measures the approximate distance from the scanning device 106 to the tag at the time of the scan. A measurement is a “proxy” distance when the scanning technology does not measure this distance directly. For example, some RFID technologies record the strength of the signal returned from each tag read during the scan, and this signal strength can be used as a proxy distance measurement. (Of course, a weaker signal means a greater proxy distance.) Other RFID technologies run a sequence of scans at different power levels to measure proxy distances. Tags read with a lower power are considered to be nearer than tags that can only be read with a higher power. Other proxy distance measurements are possible and may be used. When scanning devices 106 that determine actual distances become more widespread, their actual distance measurements can replace these proxy distances.

In many embodiments, the proxy distances are calculated on the scanning device 106, but it is possible that the scanning device 106 sends the appropriate information to the map server 110 (via the WAPs 108), and the map server 110 actually calculates the proxy distances. Similarly, steps 408 and 410, discussed below, may be performed on the scanning device 106 or on the map server 110 or on some combination of the two.

In optional step 408, the scan results are filtered. In the method under discussion, the scan results are used to determine the current location of the scanning device 106 (see discussion of step 410 below). Any merchandise tags (that is, any tags that may move around) registered during the scan are irrelevant for mapping purposes, and these tags can be filtered out. Also, the proxy distances of tags that are too far away from the scanning device 106 may be too unreliable for mapping use, and these tags may also be filtered out of the scan results.

The remaining proxy distances are then analyzed in step 410 to determine the current location of the scanning device 106. For example, a triangulation can be performed based on the known locations of the fixed tags 112 and on the proxy distances from these tags 112 to the scanning device 106. (The known locations of the fixed tags 112 can be stored in the map memory 304 of the map server 110.)

In the embodiment of FIG. 4a, the calculated current location of the scanning device 106 is sent, via the WAPs 108, to the map server 110 in step 412. In other embodiments, the map server 110 receives the relevant information (see steps 404a through 410) and calculates the current location of the scanning device 106.

Step 404b of FIG. 4b is an alternative to step 404a of FIG. 4a. In embodiments that use step 404b, the WAPs 108 record the RSSIs they are receiving from the scanning device 106 when that device transmits to the map server 110. In either embodiment 404a or 404b, a set of RSSIs between the WAPs 108 and the scanning device 106 are recorded and sent along to the map server 110 in step 414.

The map server 110 correlates the set of received RSSIs with the calculated current position of the scanning device 106 in step 416. That correlation is then used to update the map stored in the memory 304.

The above method is used to update the map. Use of the map follows known methods: When a scanning device 106 needs to know its location within the warehouse 100, it records the RSSIs that it is currently reading from the WAPs. (Alternatively, the WAPs 108 record the RSSIs they are reading from the scanning device 106.) The recorded RSSIs are sent to the map server 110. The map server 110 looks for an existing correlation that links this set of RSSIs to a location determined previously (in steps 400 through 410 of FIG. 4a or by any other method). If such a correlation is found, the map server 110 transmits the location found in the correlation to the scanning device 106. The scanning device 106 uses the received location as its current location. If an exact match of the RSSIs is not found (probably the usual case), then the map server 110 interpolates among stored RSSIs and calculates an interpolated location for the scanning device 106.

Note that in the above discussion, the actual purpose of taking the scan (e.g., for taking an inventory of the warehouse 100) does not figure prominently in the method. That is because this purpose is mostly irrelevant to the methods of the present invention. However, it is anticipated that the results of the same scan will be used both (1) for re-calibrating the map as discussed above and (2) for accomplishing whatever task the user of the scanning device 106 has been sent out to do. Thus, aspects of the present invention improve the cost efficiency of re-calibrating the map because the re-calibration need not be done as a dedicated task but can be accomplished by “piggy-backing” on scans performed for some other reason.

In view of the many possible embodiments to which the principles of the present invention may be applied, it should be recognized that the embodiments described herein with respect to the drawing figures are meant to be illustrative only and should not be taken as limiting the scope of the invention. For example, aspects of the present invention may be performed on different devices and, for example, aspects of the map server could be built into the scanning device itself. Therefore, the invention as described herein contemplates all such embodiments as may come within the scope of the following claims and equivalents thereof.

We claim:

1. A scanning device comprising:
a scan transceiver configured for transmitting a scan and for receiving results of the scan, the results comprising a list of one or more tags found by the scan;
a communications transceiver configured for communicating with a plurality of wireless access points (WAPs); and
a processor operatively coupled to the scan transceiver and to the communications transceiver, the processor configured for:
analyzing, for at least some of the tags found by the scan, proxy distances between each tag and the scanning device;
analyzing received signal strength indications (RSSIs) from signals received, via the communications transceiver, from at least some of the WAPs; and
transmitting, via the communications transceiver to a map server remote from the scanning device, at least some of the scanned-tag proxy distances and the WAP RSSIs.

2. The scanning device of claim 1 wherein the scanning device is selected from the group consisting of: an RFID scanner and a laser scanner.

3. The scanning device of claim 1 wherein at least some of the tags found by the scan are associated with fixed locations.

4. The scanning device of claim 1 wherein the communications transceiver is a WiFi transceiver.

5. The scanning device of claim 1 wherein the proxy distance for a tag found by the scan is based, at least in part, on a selection from the group consisting of: a distance measured between the tag and the scanning device, a strength of a returned signal associated with the tag, and an indication of a lowest-power scan that found the tag.

6. The scanning device of claim 1 wherein the results of the scan and the reception of signals from the WAPs to be analyzed are received essentially simultaneously.

7. The scanning device of claim 1 wherein the processor is further configured for:
filtering the list to remove tags, if any, whose proxy distances are above a threshold.

8. The scanning device of claim 1 wherein the processor is further configured for:
filtering the list to remove tags, if any, that are not associated with fixed locations.

9. The scanning device of claim 1 further comprising:
a user interface operatively coupled to the processor, the user interface configured for presenting an indication of a present location of the scanning device to a user of the scanning device;
wherein the processor is further configured for:
transmitting, via the communications transceiver to the map server, a second set of WAP RSSIs;
receiving, via the communications transceiver from the map server, an indication of a location of the scanning device; and
presenting, via the user interface to the user of the scanning device, the location indication.

10. A map server comprising:
a communications transceiver configured for communicating with a wireless access point (WAP); and
a processor operatively coupled to the communications transceiver, the processor configured for:
receiving, via the communications transceiver from a scanning device remote from the map server, proxy distances from scanned tags;
receiving, via the communications transceiver, WAP RSSIs;
analyzing at least some of the scanned-tag proxy distances to determine a location of the scanning device; and
storing, in a non-transitory computer-readable memory, a map correlating the determined location with at least some of the WAP RSSIs.

11. The map server of claim 10 wherein the WAP RSSIs are measured by the scanning device.

12. The map server of claim 10 wherein the WAP RSSIs are measured by one or more WAPs.

13. The map server of claim 10 wherein determining a location of the scanning device is based, at least in part, on fixed locations of the scanned tags as stored in a non-transitory computer-readable memory.

14. The map server of claim 10 wherein the processor is further configured for:
filtering the proxy distances to remove tags, if any, whose proxy distances are above a threshold.

15. The map server of claim 10 wherein the processor is further configure for:
filtering the proxy distances to remove tags, if any, that are not associated with fixed locations.

16. The map server of claim 10 wherein the processor is further configured for:
receiving, via the communications transceiver, a second set of WAP RSSIs;
based, at least in part, on the stored map, determining a location corresponding to the second set of WAP RSSIs; and
transmitting, via the communications transceiver, an indication of the determined location.
